(19) United States
(12) Patent Application Publication
(10) Pub. No.: US 2014/0238613 A1
(43) Pub. Date: Aug. 28, 2014

(54) LABELING MACHINE

(71) Applicant: KRONES AG, Neutraubling (DE)

(72) Inventors: Heinz Humele, Thalmassing (DE); Wolfgang Hausladen, Moetzing (DE); Christian Stoiber, Michelsneukirchen (DE); Christian Holzer, Schierling (DE)

(73) Assignee: KRONES AG, Neutraubling (DE)

(21) Appl. No.: 14/164,351

(22) Filed: Jan. 27, 2014

(30) Foreign Application Priority Data
Feb. 26, 2013 (DE) 10 2013 203 157.2

(51) Int. Cl. B65C 9/00

(52) U.S. Cl. CPC B65C 9/00
USPC 156/538

(57) ABSTRACT

A labeling machine with a rotatably driven carousel in which drive shafts for pallet shafts being parallel to the axis of rotation are rotatable, and having shaft control for rotating the drive shafts in an oscillating manner via translating gear mechanisms that are drivable by roller levers co-acting with a stationary cam system, with each gear mechanism being entirely accommodated in a capsule casing together with a supply of lubricant and the capsule casing is defined in the carousel.

### CROSS-REFERENCE TO RELATED APPLICATION

The present application claims the benefit of priority of German Application No. 10 2013 203 157.2, filed Feb. 26, 2013. The priority application is incorporated herein by reference in its entirety.

### FIELD OF THE DISCLOSURE

The disclosure relates to a labeling machine of the kind used with a carousel, such as for labeling containers.

### BACKGROUND

In such labeling machines as known from DE 30 44 879 A, DE 32 16 138 A and U.S. Pat. No. 3,736,213 A (see FIG. 7), the gear mechanism for moving the drive shaft in a rotating carousel to and fro is formed by a sprocket disposed at the lower end of the drive shaft and a roller lever with a spiral toothed segment on the peripheral side meshing with the sprocket. The roller lever is pivotable on the lower end of the drive shaft, with its cam rollers engages with the cam system imposing pivoting motions about the axis of the drive shaft, and meshes with the sprocket of the subsequent drive shaft. This design requires a relatively large overall height, a relatively large moving masses and a relatively large axial distance between rotational mounts of each drive shaft in the carousel. If selective operation of the drive shafts or pallet shafts is provided in the carousel, for example, in order to take and transfer no label in the absence of a container to be labeled, then a coupling system can be accommodated either between the sprocket on the drive shaft and the drive shaft or between a pallet shaft coupling member accessible from the top at the carousel and the drive shaft or between the drive shaft and the pallet shaft, which is operated as required by, for example, a pneumatic, individual control system accommodated in the carousel.

Other designs of shaft controls for the drive shafts of the carousel are known from U.S. Pat. No. 3,546,047, DE 1 611 911 A, WO 03/029083 A and DE 201 15 720 U.

All known shaft controls are arranged in a large, high and common gear housing in an oil bath and require elaborate seal devices. Any exchange of components of the shaft control requires dismantling the carousel and the shaft control which comprises a tremendous amount of components. The seal devices must undergo complex servicing at defined intervals. The oil ages prematurely due to ingress of water condensation. Furthermore, possible ratios of the gear mechanism are limited to a maximum of about 1:2.5, which has a negative effect on the load in the cam system and at the roller lever, since the cam system must during rotation of the carousel generate large deflections and rapid changes of direction of the roller levers in order to rotate the drive shafts far enough. In the above-mentioned known labeling machines, a drive coupling for the various assemblies of the labeling machine using complex gear mechanisms with an oil bath or circulating oil lubrication is common which entails substantial design complexity.

### SUMMARY OF THE DISCLOSURE

One aspect of the disclosure is to provide a labeling machine of the aforementioned type which can be operated virtually maintenance-free, is significantly reduced in overall height, has a minimal number of individual components and small moving masses and is characterized by running very smoothly and emitting minimal operating noise.

By using the gear mechanism fully contained in the capsule casing and by defining the capsule casing containing a supply of lubricants in the carousel, the assembly with the carousel can be operated without an oil bath. The gear mechanism and the capsule casing can be designed in an axially compact manner so that substantial overall height is reduced in the direction of the axis of rotation of the carousel. This allows an open design, while observing safety requirements, without complex, costly and high-maintenance seal systems, because no oil bath is necessary which is relatively quickly dirtied, for example, due to water condensation. The capsule casing containing the gear mechanism can optionally from the outset be designed with the desired large gear ratio, which is selectable and, if necessary, is significantly higher than previously possible ratios. Loads on the roller lever and the cam system can thereby be significantly reduced and, for example, also optimized cam tracks in the cam system can be used via the length of the roller lever, for example, because a roller setting angle in the cam track can be advantageously selected. By reducing the forces arising in the cam system due to the gear mechanism in the capsule casing, also the cam rollers in the cam system can be dry-running Since the necessary ratio of the gear mechanism is generated inside the capsule casing, the roller lever, being largely freed from any transmission function, can be light-weight and relatively delicate, causing fewer moving masses to be created and the inertial forces to be minimized due to the moderate deflections.

Under the assumption that the supply of lubricant in the capsule casing is adequate for life-time lubrication at least for the gear mechanism, the gear mechanisms are maintenance-free. The lubricant supply can also be used for lubrication of additional components contained in or engaging with the capsule casing, such as the drive shaft bearing.

In a preferred embodiment, the gear mechanism in the capsule casing is a planetary gearing with at least one stage composed of a planet gear carrier, at least one planet gear on the planet gear carrier, at least one ring gear with inner toothing, and at least one sun gear, where the planetary gearing comprises inputs and outlets being coaxial relative to the drive shaft. An advantage of the planetary gearing is an extremely compact size, especially in the axial direction, because the planet gear carrier, the ring gear and the planet gears can quasi be nested in each other, and yet have a relatively large speed increasing ratio. Relatively moderate pivoting motions of the roller lever are then sufficient to rotate the drive shaft to and fro or the pallet shaft coupled thereto, respectively, across the required rotational angle.

In an alternative embodiment, the gear mechanism in the capsule casing can be a bevel gearing at least with one inlet and one outlet bevel gear wheel, where the outlet to the drive shaft is coaxial, whereas the inlet lies below 90° to the drive shaft. Due to the inlet lying below 90° to the drive shaft, the cam track of the cam system must be arranged differently, for example, as a pot cam that can be arranged in the inner region or outer region of the carousel.

Particularly advantageously, the drive shaft is accommodated in the capsule casing, at least to a large degree, and is rotatably supported therein. The supply of lubricant for the gear mechanism can also be used to lubricate the bearing of the drive shaft. Furthermore, a short design of the drive shaft is possible, which benefits reduction of the overall height.

The roller lever is advantageously outside of the capsule casing coupled only to the inlet of the gear mechanism. In this, each roller lever, via the gear mechanism, drives its own drive shaft about the axis of which it pivots, so that it is irrelevant for the length of the roller lever which circumferential pitch is given between the drive shafts in the carousel.

In order to realize the greatest possible gear ratio, it is with the use of the planetary gearing advantageous if the inlet is formed by the planet gear carrier and the outlet by the sun gear. The sun gear can preferably be part of the drive shaft, i.e. be attached thereto or integrally formed therewith. In this manner, the drive shaft is integrated into the planetary gearing, which saves overall height in the axial direction and reduces connections.

Advantageously, a ratio is achievable at least with the planetary gearing that can amount to more than 1:2.5, so that a small pivotal motion of the roller lever (more simple cam system, better roller setting angle) is sufficient to rotate the pallet shaft to and fro, as required.

It is particularly advantageous when the capsule casing containing the gear mechanism, preferably even together with the roller lever, is an assembly in the carousel that can be fully dismantled, preferably extracted upwardly. This provides manufacturing advantages and allows rapid repair in the case of damage without the need to disassemble the entire carousel or the assembly and the need to first drain the oil.

In order to specifically save overall height of the drive shaft in the axial direction, and yet to ensure stable rotational support of the drive shaft, the drive shaft is rotatably mounted in the capsule casing with a compact roller bearing system, which uses, for example, two closely adjacent rows of roller elements and a common outer bearing ring.

For the event that the carousel comprises selective operation of each drive shaft or pallet shaft, the coupling mechanism for the selective operation can be advantageously arranged between the roller lever and the inlet of the gear mechanism. This results in considerable advantages. The coupling system is in fact relieved to a significant degree, as the coupling mechanism is located upstream of the actual gear ratio increase. And the switching pulse for the coupling system can be initiated somewhat slower when positioning the coupling system between the roller lever and the inlet of the gear mechanism. However, this should not preclude positioning the coupling mechanism between the gear mechanism and the drive shaft or between the drive shaft and the pallet shaft coupled thereto or the drive shaft and a coupling member for the pallet shaft. Actuation of the coupling, i.e. the components of the selective operation is accommodated in the carousel, in the position shown at the respective capsule casing where the coupling system is incorporated.

In order to reduce the moving masses and inertial forces, the roller lever advantageously has a weight-optimized design and is optimized with respect to the transmission of forces. With the exception of the cam rollers, it can be made of fiber-reinforced plastic, where in particular carbon fibers or fabrics containing composite materials are suggested (carbon roller lever).

In view of the elimination of an oil bath, it is furthermore advantageous if the cam system and the rollers of the roller lever are adjusted for dry-running, for example, by mutually matching the selection of material combinations, so that here as well, no oil bath or gearbox is required. This is possible, for example, by the use of double cam rollers with plastic jackets and hardened or unhardened cam tracks, optionally covered with wearing surfaces in the cam system, in combination with the large gear ratio of the gear mechanism.

In conventional labeling units, a common gear train is customary, starting from a central drive, into which the assemblies of the carousel, the glue roller, the dating device and the gripper cylinder are integrated. This gear train requires an oil bath or circulating oil lubrication and elaborate seals against oil leaks and water condensation ingress. In order to nevertheless drive the individual assemblies free of oil and synchronized to each other, it can be appropriate to assign the assemblies, or at least the assembly with the carousel an electric direct drive motor. Synchronization among the assemblies of the labeling machine is done via modern, e.g. computerized control technology. In regard to the advantage of oil-free shaft control system based to the capsule casing employed with the gear mechanisms contained therein, one solution is particularly useful where the drive of the carousel is an electric gearless direct drive motor which is installed sandwiched between the carousel and the cam system. The direct drive motor is therefore positioned in the oil-free open interior region of the carousel, which significantly saves overall height.

In this, it is advantageous when the direct drive motor comprises an inner ring armature being coupled to the carousel and rotating in a stationary stator. The stator assumes circumferential rotational support of the carousel and optionally even forms a ring casing of the assembly supporting a cam plate in the labeling machine. This ring casing, to which the cam plate can be mounted at the underside, can optionally be expanded such that the other assemblies of labeling machine can be positioned thereon so that the stator housing forms a kind of support plate structure.

Another approach is that several or all assemblies of the labeling machine that are drivable as a rotary plate, for example, the carousel, the glue roller, the dating device, the gripper cylinder and the like, are each equipped with central toothed belt pulleys and are integrated therewith in a continuous toothed belt train of a common toothed belt drive. In this, the toothed belt can be relatively rigid and not subject to deformations causing errors. The toothed belt drive is driven either by a central drive installed on or in an assembly, for example, via a direct drive motor of the carousel, or by a central drive being installed apart from the assemblies. The toothed belt pulleys in the assemblies optionally each have a defined number of teeth to obtain the desired ratios. The minimum angle of contact per toothed belt pulley can be ensured, for example, by additional deflection rollers or tension rollers. If the direction of rotation of the respective assembly does not match due to the common toothed belt drive, then intermediate gears creating the desired direction of rotation can be installed at the respective toothed belt pulley and optionally also provide an individual or required gear ratio in the respective assembly. Such intermediate gears can also assume other functions. For example, the glue roll requires varying circumferential speed during the rolling-on motion for applying glue to the pallet. With an additional stepping or overriding gear integrated into the intermediate gear, this course of motion during the glue application process can be optimized in dependency of the diameter of the glue roller, gear ratios and the like. For example, pallet wear due to relative motions between each pallet and the glue roller can thereby be avoided.

### BRIEF DESCRIPTION OF THE DRAWINGS

Embodiments of the disclosure are explained with reference to the drawings.

FIG. 1 shows an example of a labeling machine in a plan view and a schematic representation,

FIG. 2 shows a partially open perspective view of an embodiment of an assembly of the labeling machine, namely the palette carousel, in an operating position,

FIG. 3 shows a perspective view, similar to that of FIG. 2, of the carousel with an assembly being dismantled,

FIG. 4 shows a perspective partial sectional view, similar to FIGS. 2 and 3, illustrating a gearing solution,

FIG. 5 shows a schematic representation of a planetary gearing, for example, as is installed in FIG. 4, and

FIG. 6 shows a schematic sectional view of a bevel gearing which could be installed in place of the planetary gearing, for example, in FIG. 4.

### DETAILED DESCRIPTION OF THE PREFERRED EMBODIMENT

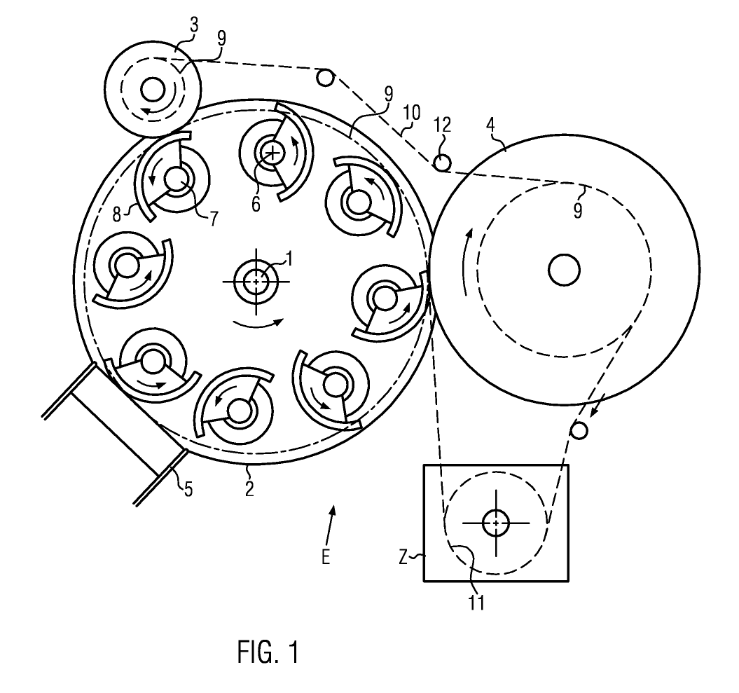

FIG. 1 illustrates in plan view and schematically a non-limiting embodiment of a labeling machine E in which a plurality of assemblies can be combined, including those that can be rotatably driven. The labeling machine E is used for labeling e.g. containers, such as bottles.

One assembly is a carousel 2 drivable about a rotational axis 1, for example, a so-called cold glue pallet carousel, which is in this embodiment associated with a glue roller 3 of a gluing unit, a gripper cylinder 4 as further rotatably drivable assemblies and a label magazine 5 as a non-rotatably drivable assembly. Not just labels of plastic or paper are processed with glue in the labeling machine E, but also tin foil cuts, logos and other decor elements.

In the carousel 2, several pallet shafts 7 are distributed along the perimeter of the carousel 2 rotatably disposed about axes of rotation 6 that are parallel to the axis of rotation 1, each of which carries at least one pallet 8 and during rotation of the carousel is oscillatingly rotatably by a drive shaft—not shown in FIG. 1—in the carousel 2 and moving to and fro, in order to obtain a respective glue application from the glue roller 3 during rotation of the carousel in an anticlockwise direction, then to receive a label from the label magazine 5, and to transfer it to the gripper cylinder 4 which applies the label to a container (not shown).

The carousel 2 can be rotatably driven by an electric gearless direct drive motor A indicated in the further figures, or conventionally by a gear train for all rotatably drivable assemblies, or, as suggested as an alternative in FIG. 1, by a toothed belt drive with a relatively rigid toothed belt 10 jointly associated with a plurality or all of the rotatably drivable assemblies, which wraps around the central toothed belt pulleys 9 provided in the rotatably drivable assemblies and is driven by a central drive Z. The central drive Z, as shown, can be installed separately from the rotatably drivable assemblies, or, not shown, be integrated into one of the rotatably drivable assemblies. The central drive Z drives the toothed belt 10 via a drive wheel 11 and is optionally guided over multiple deflection rollers and/or tension rollers 12 to ensure the required angle of contact at the toothed belt pulleys 9.

The toothed belt pulleys 9 comprise a defined number of teeth to ensure a certain gear ratio within the toothed belt drive. If the drive motion of the toothed belt 10 does not generate the correct direction of rotation for an assembly, then an intermediate gear inserted at the respective toothed belt pulley 9 can provide for the correct direction of rotation and can optionally also adjust the required ratio. The respective intermediate gear can fulfill a further function, for example, if the glue roller 3 for applying glue to the respective pallet 8 during the roll-on motion of the pallet 8 onto the glue roller 3 requires varying circumferential speed, which is produced, for example, by a stepping or overriding gear integrated into the intermediate gear, e.g. in dependency of the glue roller diameter and the respective ratio. This avoids, for example, pallet wear caused by relative motions between the pallet and the glue roller during transfer of the glue.

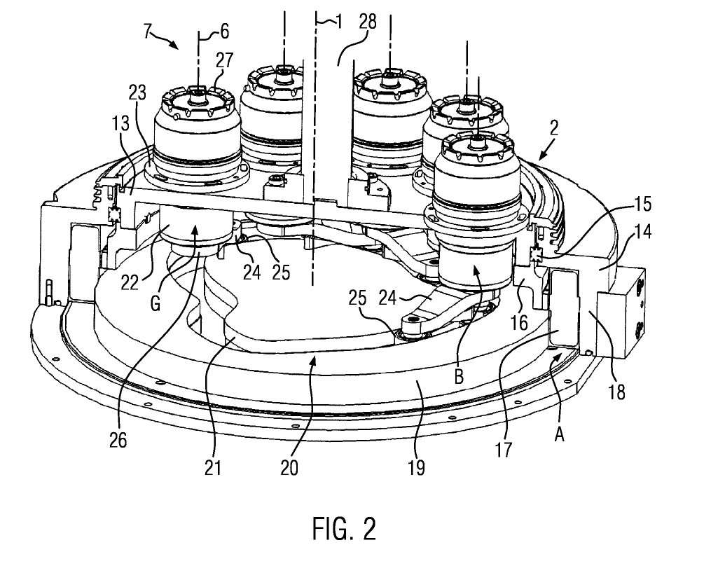

FIGS. 2 to 4 show a preferred embodiment of the assembly formed by the carousel 2 within or as a modular part of a labeling machine E.

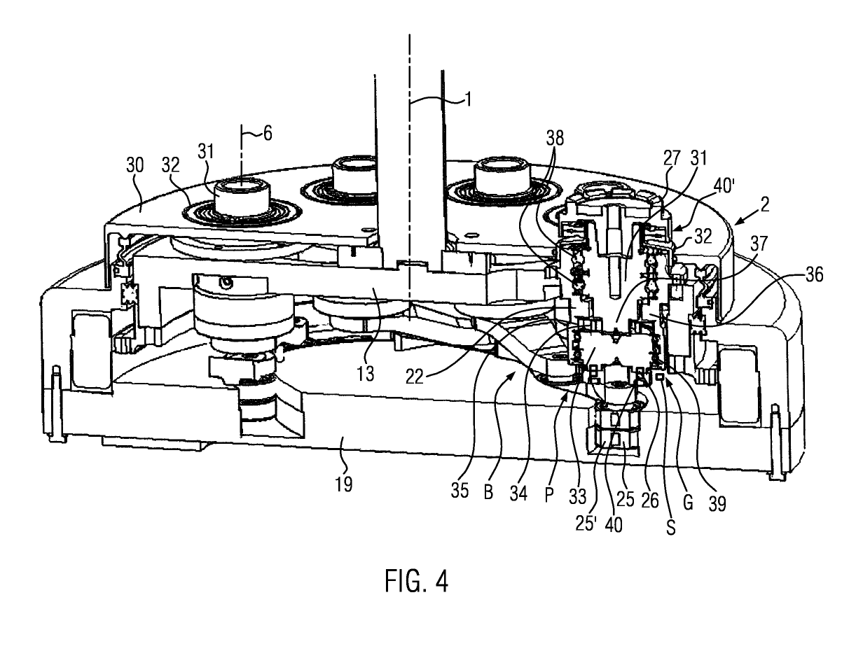

According to FIG. 2, the carousel 2 comprises a rotatably mounted disk member 13 rotating about the axis of rotation 1 and, for example, carries a column 28 for an upper support—not shown—of the pallet shafts 7. During operation, the disk 13 can be covered by a removable cover 30, as shown, for example, in FIG. 4.

Regularly spaced apertures 29 are formed in the disk body 13 along the perimeter. The disk body 13 is rotatably mounted in a stationary outer ring housing 14 by a circumferential thin-section bearing 15 and, as an electrical gearless direct drive motor A is in this embodiment provided for the carousel 2, is connected via a connecting ring 16 to an inner ring armature 17 of the direct drive motor A, which is located in a stator 18. The stator 18 is integrated into the outer ring housing 14 or constitutes it. Optionally, the outer ring housing 14 is extended for being able to modularly position thereon the further or at least one or more of the further assemblies of FIG. 1.

The direct drive motor A is sandwiched between the disk body 13 of the carousel 2 and a base plate 19 of a cam system 20 of a shaft control defined at the outer ring housing 14, so that the carousel can be designed having an extremely low overall height in the direction of the axis of rotation 8. The cam system 20 comprises at least one cam track 21 having a specific curve.

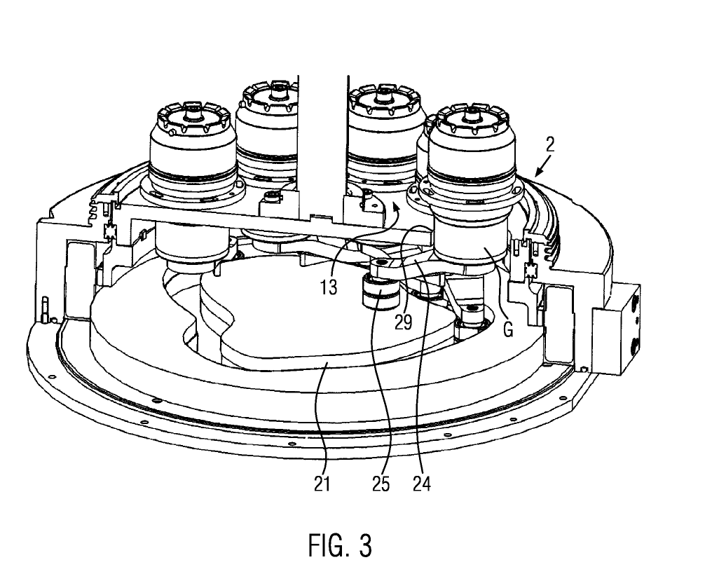

Each aperture 29 of the disk body 13 (FIG. 3) has a capsule casing 22 inserted, that can preferably be dismantled upwardly as a structural unit B and comprises a gear mechanism G for rotationally driving a drive shaft 31 shown in FIG. 4 with its upper end in the carousel 2. In the embodiments shown in FIGS. 2 to 4, the gear mechanism G comprises an inlet and an outlet coaxial to the axis 6 of the drive shaft 31, where the inlet located at the bottom is coupled to one end 26 of a roller lever 24 that can thereby rotate about the axis of rotation 6 and engages with at least one cam roller 25 in the cam track 21 and experiences deflections about the axis of rotation 6 during rotation of the disk body 13 which are transmitted to the drive shaft 31 with a increased gear ratio via the gear mechanism G.

A coupling member 27, via which the plate shaft 7—not shown—can be coupled to the drive shaft 31, is in FIGS. 2 to 4 connectable via the plate member 3 (and cover 30 in FIG. 4) to the drive shaft 31. The pallet shaft 7 is together with the at least one pallet 8 a so-called exchange set of the labeling machine E and must be exchanged for another when the label format is changed.

In FIG. 4, the coupling member 27 is bolted onto the upper end of the drive shaft 31, where the upper end of the drive shaft 31 is protected by a cap 32 in the cover 30. Furthermore, FIG. 4 indicates a coupling system 40′ of a selective operation can be disposed between the coupling member 27 and the drive shaft 31, in order to temporarily disengage the coupling member 27 from the drive shaft 31, if, for example, no label is to be received and transferred during at least one full revolution of the carousel 2.

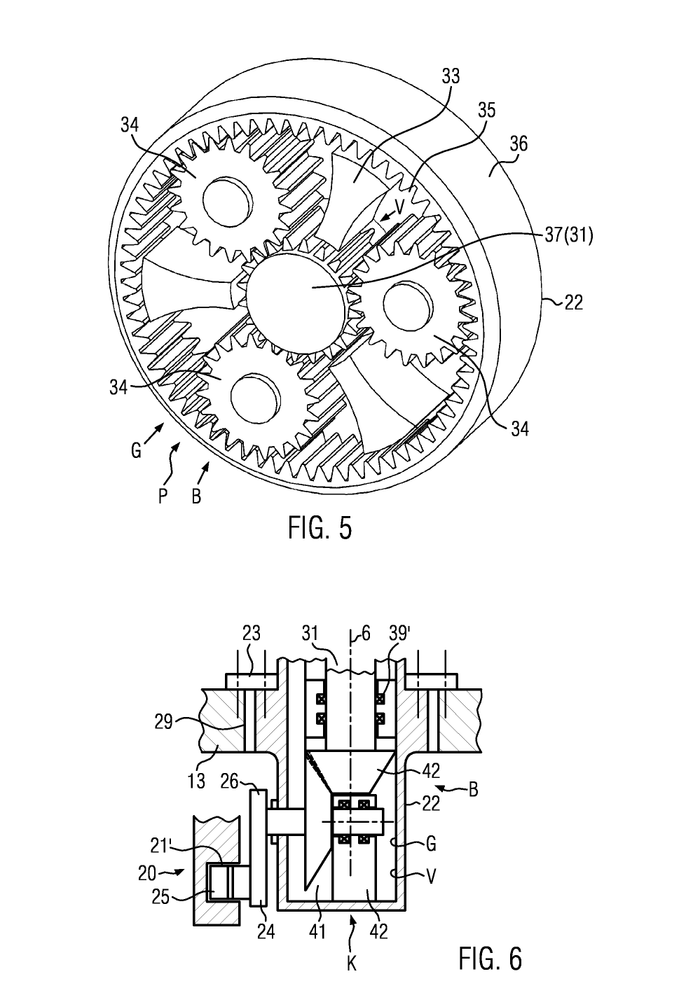

In the embodiment of the carousel 2 indicated in FIGS. 2 to 4, a planetary gearing P is contained in the capsule casing 22 as a gear mechanism G, which is also illustrated schematically in FIG. 5. The inlet of the planetary gearing P forms a planet gear carrier 33 which is rotatably mounted in the capsule casing 22, and for example, rotatably mounts a plurality of planet gears 34. An inner toothing 35 is further formed in the capsule casing 22 and is part of a ring gear 36 of the planetary gearing, where the ring gear 36 is either arranged in the capsule casing 22, or even formed by it. The planet gears 34 mesh with the inner toothing 35 of the ring gear 36 and simultaneously engage with a sun gear 37 that is connected to the lower end of the drive shaft 31 or integrally formed thereon. The drive shaft 31 is also contained in the capsule casing 22, at least for the larger part, and rotatably mounted by a compact roller bearing 38 which comprises, for example, two closely adjacent rows of roller bearings in a common outer bearing ring of the capsule casing 22 or directly in the capsule casing 22.

Instead of the coupling system 40′ between the upper end of the drive shaft 31 and the coupling member 27, particularly advantageously and as shown in FIG. 4, a coupling system 40 is disposed between the roller lever 24 and the inlet of the gear mechanism G, more precisely between the end 26 of the roller lever 24 and the planet gear carrier 33, which can be actuated as needed via a selective operation S, for example, pneumatically, disposed in the carousel, to separate the roller lever 24 from the planet gear carrier 33 or to couple it thereto.

The planetary gearing P increases the gear ratio of the motion deflection of the roller lever which can rotate to and fro about the axis of rotation 6, where a gear ratio of well over 1:2.5 can be realized.

The capsule casing 22 with the gear mechanism G, the drive shaft 31, the coupling member 27 and optionally the defined roller lever 24 forms the aforementioned structural unit B, which after removing the cover 31 and unbolting the attachment bolts of the capsule casing 22 can be upwardly dismantled from the disk body 13, as shown in FIG. 3.

The roller lever 24 is advantageously optimized in terms of weight and deformation and is made, for example, of fiber-reinforced plastic, advantageously of carbon fibers or fabrics containing composite material. The cam roller 25 of each roller lever 24 is formed as a double cam roller 25, for example, with a plastic jacket 25′ to find large-area force transmission surfaces in the cam track 21, where the cam track 21 can be hardened at the contact areas or comprise a wear-resistant coating. Dry run of the cam rollers 25 in the cam system 20 of the shaft control can thus be realized, for example, due to the mutual selection of combinations of materials between the cam rollers 25 and the cam tracks 21 of the base plate 19 which is, for example, made of steel. This is advantageously combined with the fact that the capsule casing 22 is sealed to the exterior and contains a supply of lubricant V (FIGS. 5 and 6), which is advantageously suited for life-time lubrication of at least the gear mechanism G and also of the drive shaft rotational bearing 38, so that the structural unit B is maintenance-free.

In an alternative—not shown in FIGS. 2 to 4—the direct drive motor A is not sandwiched between the base plate 19 and the disk body 13, but at the underside of the base plate 19, where the inner ring armature 17 is then coupled to a central shaft rotatably penetrating the base plate 19 and being connected to the disk body 13 above the base plate 19. The base plate 19 of this embodiment—not shown—is then attached, for example, to a support structure from below, on which the further assemblies can be positioned in a modular manner and the disk body 13 can be rotatably mounted. The stator of the electric direct drive motor is bolted from below to the base plate 19.

FIG. 5 schematically illustrates the configuration of the planetary gearing P as a gear mechanism G of the structural unit B, for example, according to FIGS. 2 to 4. The planet gear carrier 33 is rotatable in the interior of the ring gear 36 and supports the planet gears 34 which at the outside mesh with the inner toothing 35 of the ring gear 36 and simultaneously at the inside at the drive shaft 31 engage with the sun gear 37 rotating about the axis of rotation 6, where the ring gear 36 with the capsule casing 22 is supported in a rotationally fixed manner.

FIG. 6 illustrates an alternative of a gear mechanism G in the capsule casing 22 in place of the planetary gearing P of FIG. 5, where the gear mechanism G is presently designed as a bevel gearing K and comprises at least one inlet bevel gear 41 and at least one outlet bevel gear 42 meshing with each other and being rotatably mounted in the capsule casing 22 at 42 and 39′, respectively. The capsule casing 22 also contains the supply of lubricant V. The outlet bevel gear 42 can be attached to the drive shaft 31 or formed thereon. Since the inlet of the bevel gearing is oriented under 90° relative to the axis of rotation 6 of the drive shaft 31, the roller lever 24 is driven by a cam track 21′ of the cam system 20 which is formed as a pot cam and takes an upwardly and downwardly course in order to rotate the inlet bevel gear 41. The aperture 29 in the plate body 13 can be enlarged relative to the capsule casing 22 and the mounting flange 23 in order to be able to release (and insert) the cam rollers 25 from the cam track 21′ for upwardly removing the structural unit B.

At least for the assembly of the labeling machine E comprising the carousel 2, a design is essential in which no gear housing with an oil bath is required for the shaft control between the carousel 2 and the cam system 20, whereby the functionality of the assembly is improved and, above all, components and overall height can be saved. Furthermore, ease of maintenance is improved and exchange of the capsule casing 22 is conveniently and quickly possible. Omission of an oil bath also allows new drive concepts, such as direct drive motors or the like, which structurally simplify the entire labeling machine and can have modern control concepts be implemented. Many of the functional components can assume multiple functions, such as a stator housing of a direct drive motor that can even be used as a support structure for other assemblies of the labeling machine E. Furthermore, complex and cost-intensive seals requiring maintenance can be dispensed with.

Due to selectable high gear ratios in the gear mechanisms for the pallet shafts, better load situations are possible and thereby less wear of the shaft control, which in turn allows for a dry run. The selective operation is easily integrated, where the switching pulse is initiated slower than previously, in particular when a coupling system of the individual control is positioned upstream of the transmission of the gear mechanism. Omission of structurally complex gear housing with an oil bath also enables a drive concept with rigid toothed belts for several or all assemblies of the labeling machine. The labeling machine is largely maintenance-free. The assembly with the carousel is extremely slim. Any influence of water condensation collecting in the lubricating oil is avoided.

What is claimed is:

1. A labeling machine, comprising a carousel drivable about an axis of rotation provided as an assembly in which drive shafts for pallet shafts parallel to the axis of rotation are rotatably mounted;
a shaft control for rotating the drive shafts in an oscillating manner in the rotating carousel via transmitting gear mechanisms (G) that co-rotate in said carousel and that are drivable by roller levers co-acting with a stationary cam system, each gear mechanism (G) being entirely accommodated in a capsule casing together with a supply of lubricant (V) and the capsule casing being defined in the carousel.

2. The labeling machine according to claim 1, wherein the supply of lubricant (V) is in terms of quality and quantity adapted to life-time lubrication at least of the gear mechanism (G).

3. The labeling machine according to claim 1, wherein the gear mechanism (G) is a planetary gearing (P) with at least one stage composed of a planet gear carrier, at least one planet gear on the planet gear carrier, at least one ring gear fixed in the capsule casing, at least one sun gear and having an inlet and outlet being coaxial to the drive shaft.

4. The labeling machine according to claim 1, wherein the gear mechanism (G) is a bevel gearing (K) with at least inlet and outlet bevel gears, an outlet being coaxial to said drive shaft, and an inlet lying below 90° to said drive shaft.

5. The labeling machine according to claim 1, wherein the drive shaft is accommodated at least in part in the capsule casing and is rotatably mounted therein.

6. The labeling machine according to claim 3, wherein the roller lever is coupled to the inlet of the gear mechanism (G).

7. The labeling machine according to claim 3, wherein the inlet of the planetary gearing (P) is formed by the planet gear carrier and the outlet by said sun gear, that the ring gear forms the capsule casing or is defined therein, and that the sun gear is a element of the drive shaft.

8. The labeling machine according to claim 1, wherein the planetary gearing (P) or the bevel gearing (K) has a ratio of the roller lever pivot motion relative to the drive shaft rotation increased by up to more than 1:2.5.

9. The labeling machine according to claim 1, wherein the capsule casing containing the gear mechanism (G) forms a structural unit (B) in the carousel which can be completely removed.

10. The labeling machine according to claim 5, wherein the drive shaft is in the capsule casing rotatably mounted with a compact roller bearing system.

11. The labeling machine according to claim 1, and a coupling mechanism of a selective operation (S) is provided in the carousel for each drive shaft and disposed between the roller lever and the inlet of the gear mechanism (G).

12. The labeling machine according to claim 1, wherein the roller lever is formed in a weight-optimized manner.

13. The labeling machine according to claim 1, wherein the cam system and the cam rollers of the roller levers are due to the mutual selection of material combinations adjusted for dry running.

14. The labeling machine according to claim 1, wherein the drive of the carousel comprises an electric gearless direct drive motor (A) and installed sandwiched between the carousel and the cam system.

15. The labeling machine according to claim 14, wherein the direct drive motor (A) comprises an inner ring armature in a stator coupled to the carousel and forming a ring housing supporting a rotational support of the carousel on the peripheral side and a base plate of the cam system at least of the assembly of the labeling machine comprising the carousel.

16. The labeling machine according to claim 1, where at least a plurality of rotatably drivable assemblies of the labeling machine comprising the carousel, at least one glue roller, and at least one gripper cylinder are each equipped with central toothed belt pulleys and are integrated therewith in a continuous toothed belt train of a common toothed belt drive being driven by a central drive (Z) installed one of on or in an assembly or separate from the assembly.

17. The labeling machine according to claim 7, wherein the sun gear is an integrally formed element of the drive shaft.

18. The labeling machine according to claim 9, wherein the structural unit in the carousel can be completely removed with the roller lever.

19. The labeling machine according to claim 9, wherein the structural unit in the carousel can be completely removed in an upwardly direction.

20. The labeling machine according to claim 12, wherein the roller lever is formed from fiber-reinforced plastic.

21. The labeling machine according to claim 12, wherein the roller lever is formed from a composite material containing carbon fiber or fabric.

22. The labeling machine according to claim 13, wherein the cam system comprises double rollers with plastic jackets and one of hardened and unhardened cam tracks.

23. The labeling machine according to claim 22, wherein the cam tracks are coated with wearing surfaces.
